(19) United States
(12) Patent Application Publication
(10) Pub. No.: US 2013/0083308 A1
(43) Pub. Date: Apr. 4, 2013

(54) SUBSTRATE HOLDER

(71) Applicant: CARL ZEISS SMT GMBH, Oberkochen (DE)

(72) Inventors: Ulrich Mueller, Aalen (DE); Helmut Krause, Aalen (DE); Armin Bich, Aalen (DE); Franz Konle, Ellwangen (DE)

(73) Assignee: CARL ZEISS SMT GMBH, Oberkochen (DE)

(21) Appl. No.: 13/630,556

(22) Filed: Sep. 28, 2012

Related U.S. Application Data
(60) Provisional application No. 61/547,809, filed on Oct. 17, 2011.

(30) Foreign Application Priority Data
Sep. 30, 2011 (DE) 10 2011 114 875.6

(51) Int. Cl. G03B 27/58

(52) U.S. Cl. 355/72

(57) ABSTRACT

A substrate holder for receiving a substrate is provided, the substrate holder comprising a base element, at least three contact elements that are connected to the base element and arranged in a plane, wherein the substrate upon being received by the substrate holder can lie on the at least three contact elements, and wherein the contact element is connected to the base element in such a way that forces acting on the substrate in a direction of the plane are minimized by at least one contact element. Furthermore, a position measuring device for determining a positioning error of a structure element on a mask is provided, the position measuring device having a substrate holder that minimizes the forces acting on a substrate.

### CROSS-REFERENCE TO RELATED APPLICATIONS

This application claims priority U.S. provisional application 61/547,809, filed on Oct. 17, 2011, and German application 10 2011 114 875.6, filed on Sep. 30, 2011. The contents of both applications are hereby incorporated by reference in their entirety.

### TECHNICAL FIELD

This patent specification relates to a substrate holder for receiving a substrate comprising a base element, at least three contact elements, which are connected to the base element, and which are arranged in a plane, wherein the substrate upon being received by the substrate holder can lie on the at least three contact elements.

This patent specification additionally relates to a position measuring device for determining a positioning error of a structure element on a mask, which has a substrate holder disclosed here.

### BACKGROUND

In lithography for producing semiconductor components, scanners or steppers are used to project the structures of masks, which are also designated synonymously as reticles, onto wafers coated with a light-sensitive layer, the resist. Masks can be embodied, for example as “binary masks” having chromium structures on quartz glass or as phase-shift masks. Reflective masks are used for application in EUV lithography. Templates for the nanoimprint method are also counted among the masks. In mask inspection microscopes or position measuring devices, the structure of a reticle is projected onto a light-sensitive spatially resolved detector, such as a CCD chip (Charge Coupled Device), for example, with the aid of optical units.

By means of a position measuring device (registration tool), specific structure elements on a mask, such as squares, crosses or angles having predefined shapes, for example, said structure elements being designated as “registration pattern” or as “marker”, are measured and compared with their desired positions. Positions of structure elements on the mask which are part of the used structures of the mask are also measured. This is designated as “real pattern registration”. The deviation of the desired position of a structure element from the actual position thereof on the mask is the positioning error, this also being designated as “registration” or “registration error”.

In the writing process of the masks by means of electron beam writers, the measurement of the masks makes it possible to check the positional accuracy of the structures on the mask. Furthermore, the measurement of the structures of an existing set of masks makes it possible to qualify the deviation of the structure positions of the different masks for the individual lithographic layers with respect to one another.

For monitoring positions of structure elements, an aerial image of a segment of a mask is recorded by means of a position measuring device. In this case, the mask lies on a stage (also designated as specimen stage or displacing unit), which allows the mask to be shifted in the direction of the mask plane in order to make it possible to position a desired segment in the image field of the position measuring device for recording the aerial image by means of a detector. The mask is aligned prior to the measurement on a mask holder. Said mask holder is aligned on the stage, such that its position on the stage is known. Alternatively, it is also possible to effect a relative alignment of the mask with respect to specific alignment structure elements on the mask. The position determination is then effected relative to these structure elements, also designated as alignment markers. Consequently, the image can be unambiguously assigned to the absolute or relative position of the segment on the mask. By determining the position of the structure within the recorded image, it becomes possible to compare desired and actual positions of the structures on the mask and thus to calculate the positioning error.

In some examples, the requirements made of the measurement when determining positioning errors are in the order of 1 nm. It is useful to improve the measurement accuracy to, e.g., 0.5 nm in the next generation of devices.

The mounting of the mask on the stage is of great importance. As a result of the mask bearing on the mask holder, or the mask holder bearing on the stage, forces act on the substrate respectively bearing thereon. The element which is held, i.e. the mask held by the mask holder, or the mask holder held by the stage, is also designated as substrate hereinafter.

The forces acting on the substrate lead to deformations. These deformations have to have the highest possible reproducibility or be known as accurately as possible, since the reproducibility of the result of the position determination is dependent thereon.

The mask can bear, for example, on three contact elements on the mask holder. The contact elements can be embodied as hemispheres formed from a material that is as stable as possible against deformation, such as corundum, for example. Contact points of the mask that are as precisely defined and reproducible as possible on the contact elements are thus achieved.

During the bearing of the mask, force is introduced at the contact points by the weight force of the mask. This leads to a deformation of the mask, a flexure, and to a resulting stress distribution. The deformation of the mask can be calculated. For this calculation, the positions of the contact points on the mask are determined and taken into account, and the properties concerning extents, geometry and material of the mask are also taken into account. A prerequisite, however, is uniform reproducible introduction of force by all contact elements during the placement of the mask.

The determined positions of structures on the mask can be corrected on the basis of the calculated deformation, that is to say that they can be specified in a fictitious weightless state of the mask. This procedure is described in DE 102007033814, for example.

After the mask has been placed onto the mask holder, the mask holder is placed onto corresponding contact elements formed on the stage. This also involves introduction of force or introduction of stress and deformation of the mask holder by the weight force.

It has been found that upon repeated placement of the substrates, i.e. of mask onto mask holder and mask holder onto the stage, and subsequent measurement of the positions, the reproducibility of the positions determined does not meet the requirements of next-generation devices. This is attributable in part to the lack of reproducibility of the introduction of force by the contact elements. The term substrate holder denotes, on the one hand, the mask holder that receives the mask. However, a substrate holder that receives the mask holder can also be formed on the stage.

The reproducibility of the mounting of the mask on the mask holder or of the mask holder on the stage or generally the reproducibility of the mounting of a substrate on a substrate holder has not been high enough hitherto.

### SUMMARY

In general, in one aspect, a substrate holder is provided which makes it possible for a substrate to be received with high reproducibility.

In some examples, a substrate holder for receiving a substrate is provided. The substrate holder comprises
a base element,
at least three contact elements,
which are connected to the base element, and
which are arranged in a plane,
wherein the substrate upon being received by the substrate holder can lie on the at least three contact elements,
wherein the contact elements are connected to the base element in such a way that forces acting on the substrate by at least one contact element in a direction of the plane are minimized.

When a substrate is placed onto the substrate holder, the contact elements come into contact with the substrate. These locations are designated hereinafter as contact points. Owing to the desired reproducibility, it is advantageous if the contact locations are made as small as possible, i.e. punctiform to a good approximation. However, it is also possible to realize a placement in the form of extended areas. The latter are encompassed by the term contact points.

The contact elements on the substrate can be embodied in spherical fashion, for example. This means here that the contact element has a convex, spherically curved surface. An ellipsoidal surface or a higher-order freeform surface can also be involved. The counter-surface with respect to the contact elements can be a planar surface, for example. Alternatively, the contact element can have a planar surface, in which case the substrate can then have spherical supporting elements.

The roughness of the surface of the contact areas or points is intended to be as low as possible in order to enable point contact with the counter-surface.

The substrate can be embodied as a mask, for example. Masks have a planar surface. With this planar surface the mask can be placed onto contact elements embodied in a spherical fashion. In this example, the substrate holder can be embodied as a mask holder or as a stage.

The substrate can be embodied as a mask holder, for example. Said mask holder can have a planar surface, with which it can be placed onto spherical contact elements. The substrate or the mask holder can also have spherical supporting elements, with which it can be placed onto contact elements embodied in a planar fashion.

The way in which the object is achieved according to the invention is discussed below on the basis of the example of a mask on three spherical contact elements. However, this is applicable to the general case of the mounting of a substrate.

As illustrated in FIG. 2, a substrate 1a bears on three contact elements 20, 21, 22. The plane of the three contact elements is designated hereinafter as the x-y plane, and the normal to said plane as the z-direction.

The contact points 23, 24, 25 between the substrate and the contact elements are specified by the vectors \vec{rᵢ} relative to the coordinate origin 26. The forces \vec{Fᵢ} act at the contact points. FIG. 2 depicts examples of forces F1, F2 and F3 that act on the substrate 1a at the contact points 23, 24, 25.

If the mask 1a, i.e. the substrate, is at rest, then the conditions of equations 1 and 2 hold true.

\vec{F}₁+\vec{F}₂+\vec{F}₃=−\vec{F}ₑ 1

\vec{r}₁×\vec{F}₁+\vec{r}₂×\vec{F}₂+\vec{r}₃×\vec{F}₃=−\vec{M}ₑ. 2

The right-hand side of the equations respectively represent the external forces and torques. These are generally the weight force \vec{Fₑ} of the substrate and the torque \vec{Mₑ} caused thereby for accelerations of the substrate, the respective inertial forces would additionally have to be inserted on the right-hand side. The following consideration relates, however, to a substrate in the rest position. The system of equations for the nine force components consists of six conditional equations 3.

$${F}_{1 x} + {F}_{2 x} + {F}_{3 x} = - {F}_{ex} \\ {F}_{1 y} + {F}_{2 y} + {F}_{3 y} = - {F}_{ey} \\ {F}_{1 z} + {F}_{2 z} {+}_{3 z} - m g = - {F}_{ez} \\ {\sum }_{i} {r}_{iy} \cdot {F}_{iz} - {r}_{iz} \cdot {F}_{iy} = - {M}_{ex} \\ {\sum }_{i} {r}_{iz} \cdot {F}_{ix} - {r}_{ix} \cdot {F}_{iz} = - {M}_{ey} \\ {\sum }_{i} {r}_{ix} \cdot {F}_{iy} - {r}_{iy} \cdot {F}_{ix} = - {M}_{ez} \qquad 3$$

In matrix notation this can be represented as equation 4, wherein it is taken into account that \vec{rᵢ}=(xᵢ, yᵢ, zᵢ).

$$( \begin{matrix}1 & 0 & 0 & 1 & 0 & 0 & 1 & 0 & 0 \\ 0 & 1 & 0 & 0 & 1 & 0 & 0 & 1 & 0 \\ 0 & 0 & 1 & 0 & 0 & 1 & 0 & 0 & 1 \\ 0 & - {z}_{1} & {y}_{1} & 0 & - {z}_{2} & {y}_{2} & 0 & - {z}_{3} & {y}_{3} \\ {z}_{1} & 0 & - {x}_{1} & {z}_{2} & 0 & - {x}_{2} & {z}_{3} & 0 & - {x}_{3} \\ - {y}_{1} & {x}_{1} & 0 & - {y}_{2} & {x}_{2} & 0 & - {y}_{3} & {x}_{3} & 0\end{matrix} ) \cdot ( \begin{matrix}{F}_{1 x} \\ {F}_{1 y} \\ {F}_{1 z} \\ {F}_{2 x} \\ {F}_{2 y} \\ {F}_{2 z} \\ {F}_{3 x} \\ {F}_{3 y} \\ {F}_{3 z}\end{matrix} ) = - ( \begin{matrix}{F}_{ex} \\ {F}_{ey} \\ {F}_{ez} \\ {M}_{ex} \\ {M}_{ey} \\ {M}_{ez}\end{matrix} ) \qquad 4$$

Without restricting general validity, the x/y plane of the coordinate system is placed into the plane of the three contact points. In the general case, the center of gravity of the substrate does not lie at the coordinate origin. In the case of a mask, it lies above the plane of the three contact points (i.e. the x/y plane). The resultant torque is contained in the external torques \vec{Mₑ}. Rearranging equation 4 yields an equation system of equation 5 in block diagonal form.

$$( \begin{matrix}1 & 0 & 1 & 0 & 1 & 0 & 0 & 0 & 0 \\ 0 & 1 & 0 & 1 & 0 & 1 & 0 & 0 & 0 \\ - {y}_{1} & {x}_{1} & - {y}_{2} & {x}_{2} & - {y}_{3} & {x}_{3} & 0 & 0 & 0 \\ 0 & 0 & 0 & 0 & 0 & 0 & {y}_{1} & {y}_{2} & {y}_{3} \\ 0 & 0 & 0 & 0 & 0 & 0 & - {x}_{1} & - {x}_{2} & - {x}_{3} \\ 0 & 0 & 0 & 0 & 0 & 0 & 1 & 1 & 1\end{matrix} ) \cdot ( \begin{matrix}{F}_{1 x} \\ {F}_{1 y} \\ {F}_{2 x} \\ {F}_{2 y} \\ {F}_{3 x} \\ {F}_{3 y} \\ {F}_{1 z} \\ {F}_{2 z} \\ {F}_{3 z}\end{matrix} ) = - ( \begin{matrix}{F}_{ex} \\ {F}_{ey} \\ {F}_{ez} \\ {M}_{ex} \\ {M}_{ey} \\ {M}_{ez}\end{matrix} ) \qquad 5$$

The force components in a direction of the x/y plane and the force components in the z-direction separate in equation 5. The resulting matrix for the force components in the z-direction is given in equation 6.

$$( \begin{matrix}{y}_{1} & {y}_{2} & {y}_{3} \\ - {x}_{1} & - {x}_{2} & - {x}_{3} \\ 1 & 1 & 1\end{matrix} ) \cdot ( \begin{matrix}{F}_{1 z} \\ {F}_{2 z} \\ {F}_{3 z}\end{matrix} ) = - ( \begin{matrix}{M}_{ex} \\ {M}_{ey} \\ {F}_{ez}\end{matrix} ) \qquad 6$$

Equation 6 is exactly solvable provided that the coefficient determinant of the 3×3 matrix does not become zero. Equation 6 would be unsolvable only for arrangements which are not relevant in practice, for example if the three contact points lie on a straight line or coincide at a point.

The z-components of the forces and the weight force result in internal torques which bend the substrate. This flexure of the substrate, as mentioned initially, is calculated and the measured values of the positions determined are correspondingly corrected.

Equation 7 for the force components acting in the x/y direction, i.e. in a direction of the plane, is underdetermined. A 3-dimensional space opens up in which arbitrary combinations of force components are possible.

$$( \begin{matrix}1 & 0 & 1 & 0 & 1 & 0 \\ 0 & 1 & 0 & 1 & 0 & 1 \\ - {y}_{1} & {x}_{1} & - {y}_{2} & {x}_{2} & - {y}_{3} & {x}_{3}\end{matrix} ) \cdot ( \begin{matrix}{F}_{1 x} \\ {F}_{1 y} \\ {F}_{2 x} \\ {F}_{2 y} \\ {F}_{3 x} \\ {F}_{3 y}\end{matrix} ) = - ( \begin{matrix}{F}_{ex} \\ {F}_{ey} \\ {M}_{ez}\end{matrix} ) \qquad 7$$

If the contact elements are rigidly fixed to the base element 30, the static friction between substrate and the contact points limits the maximum absolute value of the force components in the x/y direction. This leads to the secondary condition from equation 8. In this case, μ is the coefficient of static friction between substrate and contact element.

\sqrt{Fᵢₓ²+F_{iy}²}<μ·F_{iz}

Each time the substrate is lifted off and emplaced again, a random division of the force components in the x/y direction will be established. These force components can cause internal stresses of the substrate. A lateral deformation results therefrom. Said lateral deformation is randomly distributed and cannot be eliminated either by a correction or by a calibration.

In some implementations, the forces acting on the substrate in a direction of the plane by virtue of the contact elements, that is to say forces in the x/y direction having the components Fᵢₓ and F_{iy}, are now minimized.

The minimization of these forces minimizes the randomly distributed division of the force components in the x/y direction. These minimized force components can be equal to zero to a good approximation. A randomly distributed, i.e. non-reproducible, deformation of the substrate is thus avoided to the greatest possible extent. The directions in the plane in which the forces are minimized are also designated hereinafter as compensation directions.

The contact elements can differ with regard to the compensation directions. A contact element can act in all compensation directions or can act only in one compensation direction. It is possible to combine contact elements which act in a different number of compensation directions. It is also possible to combine rigid contact elements with contact elements which act in one or a plurality of compensation directions.

In some implementations, the forces acting on the substrate are minimized in one respective direction per contact element.

In this configuration, the forces are minimized in preferred directions within the plane, i.e. directions within the x/y directions. The number of directions, which can also be designated as degrees of freedom, corresponds here to the number of contact elements. In the case of three contact elements, the forces are minimized in a direction of the plane in three directions. In order to achieve this, by way of example, the connections between contact element and base element can be so flexible that the contact elements are arranged freely movably in the corresponding directions.

In some implementations, the force acting on the substrate is minimized in one direction by each contact element.

In a continuation of the example explained above, this measure will be discussed on the basis of a mask resting on three spherical contact elements. As is illustrated in FIG. 2, a substrate 1a again bears on three contact elements 20, 21, 22. At the contact points 23, 24 and 25, three local coordinate systems for the radial directions e_{1R}, e_{2R} and e_{3R} and three local coordinate systems for the tangential direction e_{1T}, e_{2T} and e_{3T} are defined, as specified in equations 9 and 10, where i=1, 2 and 3.

$$\begin{matrix}{\vec{e}}_{iR} = \frac{1}{{r}_{i}} ( \begin{matrix}{x}_{i} \\ {y}_{i}\end{matrix} ) ≡ ( \begin{matrix}cos {φ}_{i} \\ sin {φ}_{i}\end{matrix} ) where \\ {r}_{i} = \sqrt{{x}_{i}^{2} + {y}_{i}^{2}} & 9 \\ {\vec{e}}_{iT} = ( \begin{matrix}- sin {φ}_{i} \\ cos {φ}_{i}\end{matrix} ) & 10\end{matrix}$$

In the new base system, equations 11 and 12 hold true for the radical forces F_{iR} and for the tangential forces F_{iT}.

F_{iR}=\vec{F}ᵢ·\vec{e}_{iR} and respectively F_{iT}=\vec{F}ᵢ·\vec{e}_{iT} therefore 11

$$( \begin{matrix}{F}_{iR} \\ {F}_{iT}\end{matrix} ) = ( \begin{matrix}cos {φ}_{i} & sin {φ}_{i} \\ - sin & cos {φ}_{i}\end{matrix} ) \cdot ( \begin{matrix}{F}_{ix} \\ {F}_{iy}\end{matrix} ) \qquad 12$$

The force components Fᵢₓ and F_{iy} can be represented as a function of the radial forces F_{iR} and tangential forces F_{iT}, as can be seen from equations 13 and 14.

Fᵢₓ=F_{iR}·\vec{e}_{iR}·\vec{e}ᵢₓ+F_{iT}·\vec{e}_{iT}·\vec{e}ᵢₓ etc. therefore 13

$$( \begin{matrix}{F}_{ix} \\ {F}_{iy}\end{matrix} ) = ( \begin{matrix}cos {φ}_{i} & - sin {φ}_{i} \\ sin {φ}_{i} & cos {φ}_{i}\end{matrix} ) \cdot ( \begin{matrix}{F}_{iR} \\ {F}_{iT}\end{matrix} ) \qquad 14$$

Inserting equation 14 into equation 7 yields equation 15.

$$( \begin{matrix}1 & 0 & 1 & 0 & 1 & 0 \\ 0 & 1 & 0 & 1 & 0 & 1 \\ - {y}_{1} & {x}_{1} & - {y}_{2} & {x}_{2} & - {y}_{3} & {x}_{3}\end{matrix} ) \cdot ( \begin{matrix}\begin{matrix}cos {φ}_{1} & - sin {φ}_{1} \\ sin {φ}_{1} & cos {φ}_{1}\end{matrix} & 0 & 0 \\ 0 & \begin{matrix}cos {φ}_{2} & - sin {φ}_{2} \\ sin {φ}_{2} & cos {φ}_{2}\end{matrix} & 0 \\ 0 & 0 & \begin{matrix}cos {φ}_{3} & - sin {φ}_{3} \\ sin {φ}_{3} & cos {φ}_{3}\end{matrix}\end{matrix} ) \cdot ( \begin{matrix}{F}_{1 R} \\ {F}_{1 T} \\ {F}_{2 R} \\ {F}_{2 T} \\ {F}_{3 R} \\ {F}_{3 T}\end{matrix} ) = - ( \begin{matrix}{F}_{ex} \\ {F}_{ey} \\ {M}_{ez}\end{matrix} ) \qquad 15$$

Equation 17 follows from equation 15 using the relationship from equation 16 (orthogonality relation of equations 9 and 10).

$$\begin{matrix} \begin{matrix}- {y}_{1} \cdot ( cos {φ}_{1} ) + {x}_{1} sin {φ}_{1} = 0 ; & - {y}_{1} \cdot ( - sin {φ}_{1} ) + {x}_{1} cos {φ}_{1} = {r}_{1}\end{matrix} & 16 \\ ( \begin{matrix}cos {φ}_{1} & - sin {φ}_{1} & cos {φ}_{2} & - sin {φ}_{2} & cos {φ}_{3} & - sin {φ}_{3} \\ sin {φ}_{1} & cos {φ}_{1} & sin {φ}_{2} & cos {φ}_{2} & sin {φ}_{3} & cos {φ}_{3} \\ 0 & {r}_{1} & 0 & {r}_{2} & 0 & {r}_{3}\end{matrix} ) \cdot ( \begin{matrix}{F}_{1 R} \\ {F}_{1 T} \\ {F}_{2 R} \\ {F}_{2 T} \\ {F}_{3 R} \\ {F}_{3 T}\end{matrix} ) = - ( \begin{matrix}{F}_{ex} \\ {F}_{ey} \\ {M}_{ez}\end{matrix} ) & 17\end{matrix}$$

Equation 17 makes it possible to show that the radial components F_{iR} of the forces have no effect on the torque M_{ez}.

When minimizing the radial components of the forces F_{iR} using suitable mechanical means, equation 18 approximately holds true.

F_{iR}=0 18

Under this precondition of equation 18, equation 17 becomes an exactly solvable equation system of equation 19.

$$( \begin{matrix}- sin {φ}_{1} & - sin {φ}_{2} & - sin {φ}_{3} \\ cos {φ}_{1} & cos {φ}_{2} & cos {φ}_{3} \\ {r}_{1} & {r}_{2} & {r}_{3}\end{matrix} ) \cdot ( \begin{matrix}{F}_{1 T} \\ {F}_{2 T} \\ {F}_{3 T}\end{matrix} ) = - ( \begin{matrix}{F}_{ex} \\ {F}_{ey} \\ {M}_{ez}\end{matrix} ) \qquad 19$$

From equation 19, the tangential forces are determined unambiguously from the boundary conditions. The directions in which the remaining tangential forces act should be chosen such that the coefficient determinant of equation 19 is not equal to zero.

$$det ( A ) ≡ det ( \begin{matrix}- sin {φ}_{1} & - sin {φ}_{2} & - sin {φ}_{3} \\ cos {φ}_{1} & cos {φ}_{2} & cos {φ}_{3} \\ {r}_{1} & {r}_{2} & {r}_{3}\end{matrix} ) \neq 0 \qquad 20$$

In order to meet this condition of equation 20, the directions in the plane in which the radial forces F_{iR} are minimized have to intersect at a point.

Examples of arrangements which meet this condition are illustrated in FIGS. 3 to 5. In these figures, substrate mask and base element or mask holder and the contact elements and contact points have the same reference signs as in FIG. 2. The three directions in the plane in which the radial forces F_{iR} are minimized are the compensation directions here and are designated by the letters R₁, R₂ and R₃. These compensation directions are illustrated as arrows in the figures.

In a first variant, illustrated in FIG. 3, the contact elements and the contact points are arranged as corners of an equilateral triangle. The compensation directions R₁, R₂ and R₃ run from the contact points in the direction of midpoint S₁ of the triangle. Intersection point S₁ and origin of the coordinate system coincide in the schematic diagram in FIG. 3.

In a second variant, as depicted schematically in FIG. 4, two compensation directions R₄, R₅ and the intersection point S₁ of all the compensation directions lie on a straight line.

In a third variant, as depicted schematically in FIG. 5, the intersection point S₁ of all the compensation directions lies outside the area spanned by the contact elements.

This measure has the advantage that the forces that lead to a non-reproducible deformation of the substrate are minimized, but at the same time the substrate is held stably in a position.

Moreover, the arrangement is stable against misalignment. If a compensation direction deviates from the predefined desired direction, such that it does not run through the intersection point S₁, the forces are nevertheless compensated for to a greater extent.

In a further configuration of the invention, as depicted schematically in FIG. 6, the force acting on the substrate at a first contact element 21 is minimized in all directions R₇, R₈, and the force acting on the substrate at a second contact element 22 is minimized in one direction R₉.

The third contact element 20 is rigidly connected to the base element.

Mechanically structural means ensure that the first contact element 21 is soft, i.e. forces (F₃) are minimized in all compensation directions, i.e. in all directions of the plane. The force components F₃ₓ and F_{3y} in equation 7 thus become equal to zero to a good approximation. Two compensation directions R₇, R₈ of the first contact element, which are arranged at right angles to one another, as is illustrated in FIG. 6, are equivalent.

For simpler calculation, the origin of the coordinate system is placed at the contact point of the third contact element 23.

Analogously to equations 9 and 10, a local coordinate system for the radial direction e_{2R} and one for the tangential direction e_{2T} are defined at the second contact point 22.

The equation system of equation 21 arises analogously to the above considerations.

$$( \begin{matrix}1 & 0 & cos {φ}_{2} & - sin {φ}_{2} \\ 0 & 1 & sin {φ}_{2} & cos {φ}_{2} \\ {x}_{1} & {y}_{1} & 0 & {r}_{2}\end{matrix} ) \cdot ( \begin{matrix}{F}_{1 x} \\ {F}_{1 y} \\ {F}_{2 R} \\ {F}_{2 T}\end{matrix} ) \cdot = - ( \begin{matrix}{F}_{ex} \\ {F}_{ey} \\ {M}_{ez}\end{matrix} ) \qquad 21$$

By minimizing the radial components of the force F_{2R} at the second contact element using suitable mechanical means, i.e. the approximation from equation 18, equation 21 becomes an exactly solvable equation system.

The compensation direction of the second contact element lies in a direction of the connection of the second and third contact points.

In some implementations, the contact element has a solid-state articulation for minimizing the forces.

In some implementations, the solid-state articulation has a flexible element enabling a movement of the contact element for minimizing the forces in a compensation direction.

The use of solid-state articulations has the advantage that force compensation in one or else in a plurality of compensation directions is made possible in a simple manner. Solid-state articulations can be manufactured precisely and, for the usually small deflections required, the movements are of high reproducibility.

A solid-state articulation can be embodied as a hinge in order to enable compensation in one compensation direction. It can also be embodied as a flexible rod in order thus to enable compensation in all compensation directions.

In a further configuration of the invention, the solid-state articulation has at least two flexible elements arranged parallel.

This measure has the advantage of achieving a higher stability against undesirable movements which do not take place in a direction of the compensation direction. This is advantageous for an exact positioning or for the stability of a position of a substrate.

In a further configuration of the invention, the solid-state articulation has at least two flexible elements which are embodied as webs and which enable a compensation movement parallel to the plane.

In the case of this measure, by way of example, a rectangular plate is connected to a frame at two opposite sides by means of flexible webs. The plate is thus arranged movably perpendicular to the direction of the webs. The plate can be arranged horizontally on a stage or on a mask holder.

This measure has the advantage that a compensation movement is made possible in which the contact point remains at a constant level during the movement. As a result of the plate being linked to a frame on two sides, a high dimensional stability and thus a high reproducibility of the movement are made possible.

In some implementations, the contact element has a sphere arranged in a rotatable fashion.

This measure has the advantage that it can be provided in a comparatively simple manner. Thus, it is possible in a simple manner, for example, to arrange a sphere having a planar surface on a planer plane.

In some implementations, the sphere bears on a planar surface arranged parallel to the plane.

It is possible in a simple manner, for example, to arrange a sphere having a planar surface on a planar plane. The sphere then moves, i.e. rolls, in all compensation directions. The rolling resistance of the sphere is very low. The positioning of the sphere has a high reproducibility.

In some implementations, the sphere lies in a groove running in the direction of the plane.

These measures have the advantage that the compensation directions can be fixed to a compensation direction along the groove in a simple manner.

The sphere can be arranged freely movably in a straight V-shaped groove, for example. In some implementations, the sphere is held by securing elements in an initial position.

If a mask is placed onto three contact elements, for example, then the positions of the contact points between mask and contact element have to be known. In order to achieve this, it is helpful if the positions of the contact elements are defined. What is achieved by means of the securing elements is that the spheres on whose surface the mask will rest already have defined positions before the placement of the mask.

The securing elements have horizontally arranged flexible tongues, for example, which are in contact with the surface in the rest position. As soon as the sphere moves, said tongues are correspondingly bent.

In a further configuration of the invention the sphere bears on at least two flexible supporting elements.

The sphere can bear, for example, on two or else three mutually facing surfaces of the supporting elements. A supporting element has a flexible rod, for example, which runs in a direction of the normal to the bearing surfaces. If a planar substrate bearing on the sphere exerts a force on the sphere which would lead to a rolling movement in the case of the measures mentioned above, a rotation of the sphere is now achieved by means of bending of the flexible rods. This rotational movement corresponds to a good approximation to a movement around the midpoint of the sphere.

This measure has the advantage that the forces are compensated for, but the contact point does not change the position in the plane with respect to the base element.

In a further configuration of the invention, the contact element has three spheres arranged in a movable fashion between two planar surfaces.

This measure has the advantage that force compensation in all compensation directions is possible, but the movements are dimensionally stable and of high reproducibility.

In a further configuration of the invention, a contact element has in each case two contact points, wherein the forces acting on the contact element are directed at least partly counter to one another.

This measure is advantageous particularly when the intention is for the substrate holder to receive a substrate with high reproduceability during the positioning.

By way of example, the forces \vec{F}ᵢ are respectively input at six contacts points \vec{r}ᵢ. The sum of the forces at the contact points then results from equation 22, and the sum of the torques from equation 23:

$$\begin{matrix}{\sum }_{i = 1 … 6} {\vec{F}}_{i} = - {\vec{F}}_{e} & 22 \\ {\sum }_{i = 1 … 6} {\vec{r}}_{i} \times {\vec{F}}_{i} = - {\vec{M}}_{e} & 23\end{matrix}$$

In the general case, the forces can act at the contact points in all three spatial directions, i.e. in three degrees of freedom, since, besides the deformation force in a direction of the normal to the contact surface, the friction forces can also act in the directions of the plane.

Combining the components from equations 22 and 23 to form column vectors yields equations 24 and 25 for the forces and the external torques at the contact points:

\tilde{F}ᵢ=(F₁ₓF₂ₓF_{3z} . . . F_{6y}F_{6z})′: 24

\tilde{F}Pₑ=(Fₑₓ F_{ey}F_{ez}MₑₓM_{ey}M_{ez})′ 25

The equation system 26 to be solved is then underdetermined.

Ã·\tilde{F}ᵢ=−\tilde{F}ₑ 26

It contains in the matrix Ã the geometry of the contact points relative to a reference coordinate system also indicating the external torques.

In order to constructively eliminate the underdetermination, the number of forces which act at the contact point and the directions of said forces are varied.

This opens up an almost unlimited diversity of geometrical possibilities for arranging the six contact points and the n directions. A pre-stress is useful for a reproducible positioning. In one variant, by means of skillfully inclined planar surfaces what is achieved is that solely the gravitational force provides for the necessary pre-stress at the connecting points.

In some implementations, there are six contact points between the contact elements and the substrate.

In one variant of the method, after the substrate has been received, there are two contact points between each of three contact elements and the substrate.

The two measures mentioned above have the advantage that a symmetrical arrangement of the contact elements is possible. The latter can lie, for example, at the corners of an equilateral triangle. A substrate holder can then be emplaced in different positions that respectively differ by a rotation of 120°.

In some implementations, the substrate holder is embodied as a mask holder.

In some implementations, the substrate holder is embodied as a stage.

In some implementations, a position measuring device is provided for determining a positioning error of a structure element on a mask, which has a substrate holder disclosed here.

The invention is explained and described in greater detail below on the basis of some selected exemplary embodiments and with reference to the drawings.

### BRIEF DESCRIPTION OF THE DRAWINGS

FIG. 1 schematically shows the construction of a position measuring device with a configuration of contact elements, which are illustrated in detail in FIGS. 7 and 8.

FIG. 2 to FIG. 6 are plan views of a mask on a mask holder with contact elements.

FIG. 7 is a schematic view of a section along the line I-I of the contact elements from FIG. 8, which has a solid-state hinge.

FIG. 8 is a schematic side view of a contact element having a solid-state hinge.

FIG. 9 is a schematic view of a contact element having a solid-state hinge with a plurality of flexible elements.

FIG. 10 is a schematic view of a contact element having a horizontally movable plate.

FIG. 11 is a schematic view of a section along the line I-I of the contact element from FIG. 10.

FIG. 12 is a schematic side view of a section along the line II-II of the contact element from FIG. 13 with a sphere on a planar plate.

FIG. 13 is a schematic plan view of a section along the line I-I of the contact element from FIG. 12.

FIG. 14 is a schematic side view of a contact element with a sphere in a groove.

FIG. 15 is a schematic side view of a contact element with two flexible supporting elements.

FIG. 16 is a schematic view of a section of a contact element with two flexible supporting elements.

FIG. 17 is a schematic side view of a further contact element with two flexible supporting elements.

FIG. 18 is a schematic side view of a contact element with three spheres between two plates.

FIG. 19 is a schematic side view of a contact element with three spheres between two plates.

FIG. 20 is a schematic plan view of a mask holder on a stage.

FIG. 21 is a schematic sectional drawing of a contact element of the mask holder from FIG. 20 along the line I-I in FIG. 20.

### DETAILED DESCRIPTION

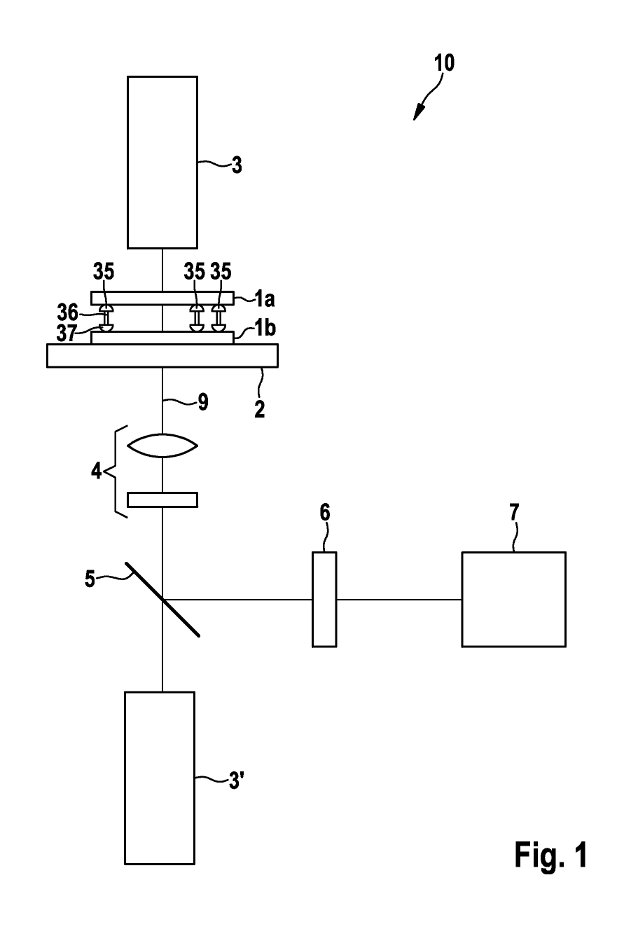

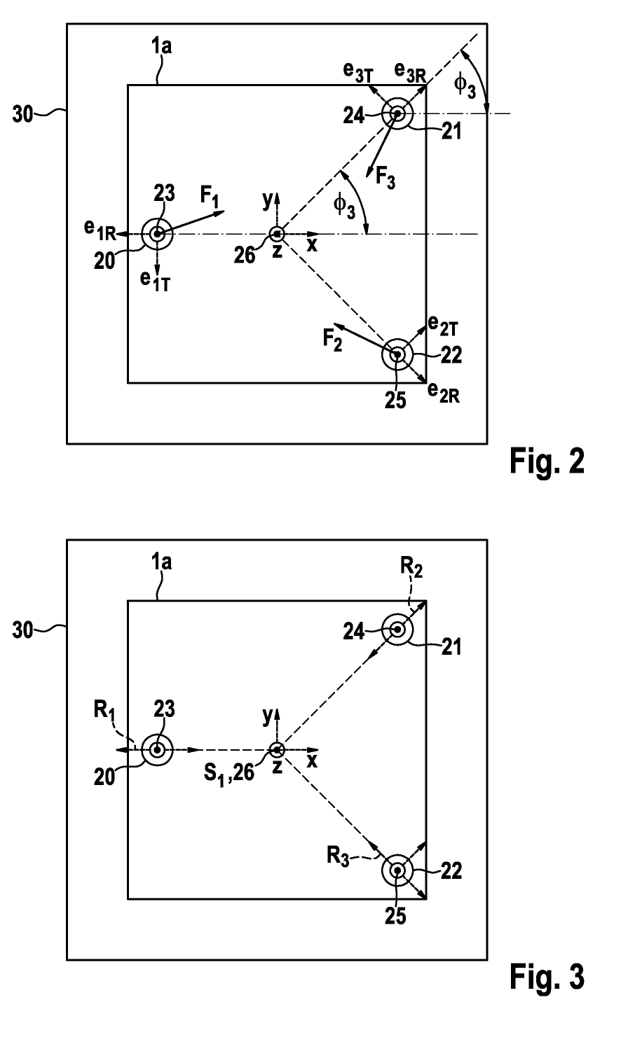

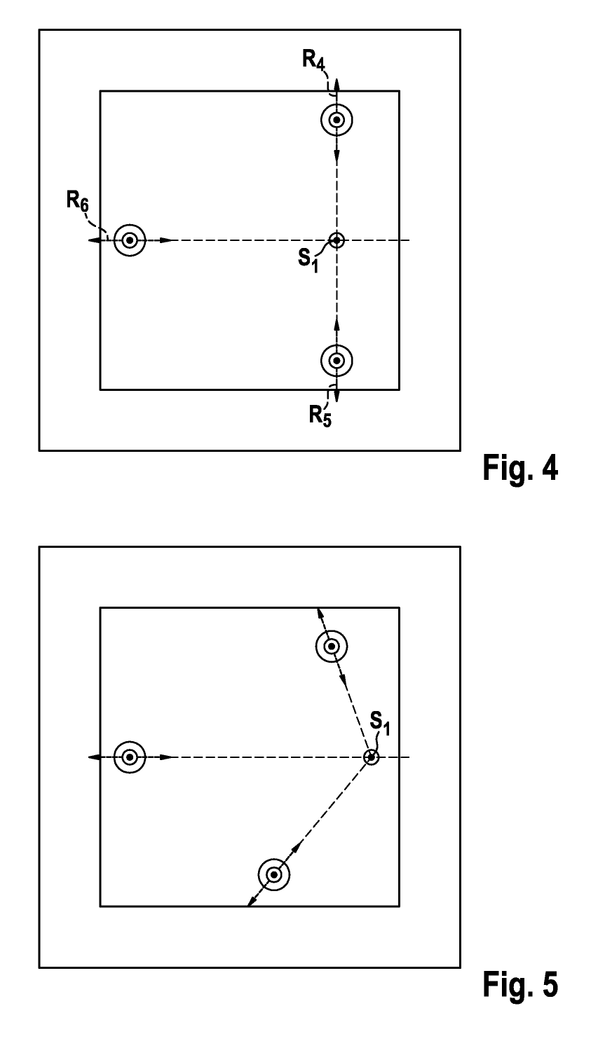

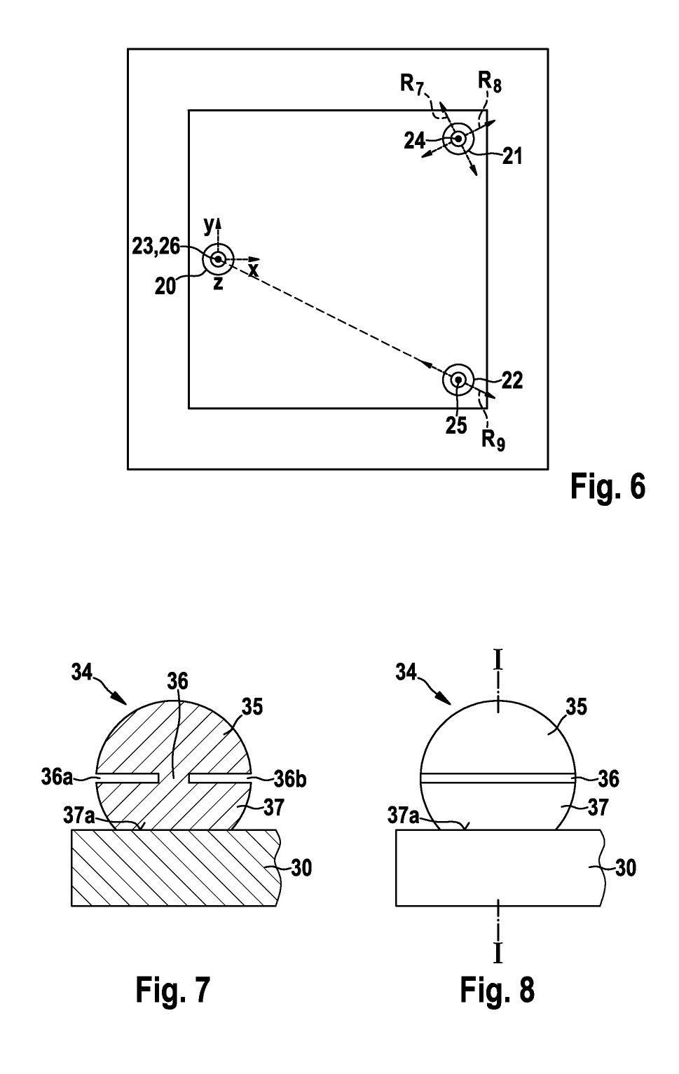

FIG. 1 shows a position measuring device 10, which serves for measuring the position of structures on masks.

A mask 1a for photolithography is mounted on a stage 2. Mask 1a lies on three hemispheres 35 that are parts of the contact elements 34. The hemispheres 35 are flexibly connected to connecting elements 37 by means of solid-state hinges 36. The connecting elements 37 are connected to a mask holder 1b. The mask holder 1b lies on the stage 2. The stage 2 can be displaced for positioning the mask 1 in three spatial directions. In order to ensure a high accuracy, the current position or the path difference is monitored by means of laser-interferrometric or further high-precision measuring instruments (not shown). The mask 1a and the stage 2 are arranged horizontally, and the mask plane is also designated as the x-y plane. An illumination device 3 is arranged above the stage 2 with the mask 1a. The illumination device 3 contains at least one illumination source which emits illumination light and which illuminates the mask via an illumination beam path. The illumination light source can be configured, for example, as a laser that emits light having the wavelength of 193 nm. The illumination device 3 serves for transmitted-light illumination of the mask 1a. A further illumination device 3′ is situated on the other side of the stage 2, the further illumination device 3′ serving to illuminate the mask 1a using reflected light.

A segment of the mask 1 that is situated in the image field is imaged either by the light passing through the mask 1a, or by the light reflected from it, via an imaging optical unit 4 and a beam splitter 5 onto a spatially resolving detector 6 configured as a charged coupled device (CCD) camera. The optical axis of the imaging optical unit 4 is designated by the reference sign 9, and its direction is designated as the Z-direction. The plane of the mask is also designated as the x-y plane. The detected intensities of the first aerial image are digitalized by a control unit 7, which is embodied as a computer with screen, and are stored as a gray-scale image. For example, the image can be formed as a matrix of 1000*1000 pixels made from intensity values.

In order to record an aerial image of the mask 1a, the latter is aligned in the x-y plane in such a way that the desired region becomes situated in the image field of the position measuring device and is imaged onto the detector 6. After the best focal plane has been determined by the stage 2 being displaced in the z-direction, a gray-scale image is recorded by detector 6 and control unit 7.

Numerous configurations of contact elements which reduce (e.g., minimize) the forces on the mask in one or in a plurality of compensation directions are described below. FIGS. 7, 8, 12 to 19 and 21 illustrate segments of the respective substrates, without this being mentioned anew in the following description.

A first contact element 34 consists of a hemisphere 35 connected to a connecting element 37 by means of a solid-state articulation 36, as illustrated in the sectional view in FIG. 7 and in the side view in FIG. 8. The connecting element 37 is connected to the base element 30, which is embodied as a mask holder here. The hemisphere 35 is movable perpendicular to the solid-state articulation 36. Hemisphere 35, solid-state articulation 36 and connecting element 37 have the shape of a sphere, with a flattened bottom 37a. The sphere is fixed by the bottom 37a on the mask holder 30. The solid-state articulation was obtained by the introduction of slots 36a, 36b into the sphere. This contact element 34 makes it possible to minimize the forces in a compensation direction predefined by the solid-state articulation 36.

In one configuration, this contact element 34 is fixed on a mask holder 30 and is used for the bearing of masks. The mask then lies on the top side of the hemisphere 35. In a further variant, the contact element 34 is arranged on a stage 2 and serves for bearing mask holders with a planar underside.

In a variant of the contact element 34 that is not illustrated in the figures, the solid-state articulation 36 is embodied as a web with a round or square web that connects the hemisphere 35 and the connecting element 37. Analogously to the slots 36a, 36b, a slot then runs circumferentially with respect to the web. The hemisphere is then embodied movably in all compensation directions.

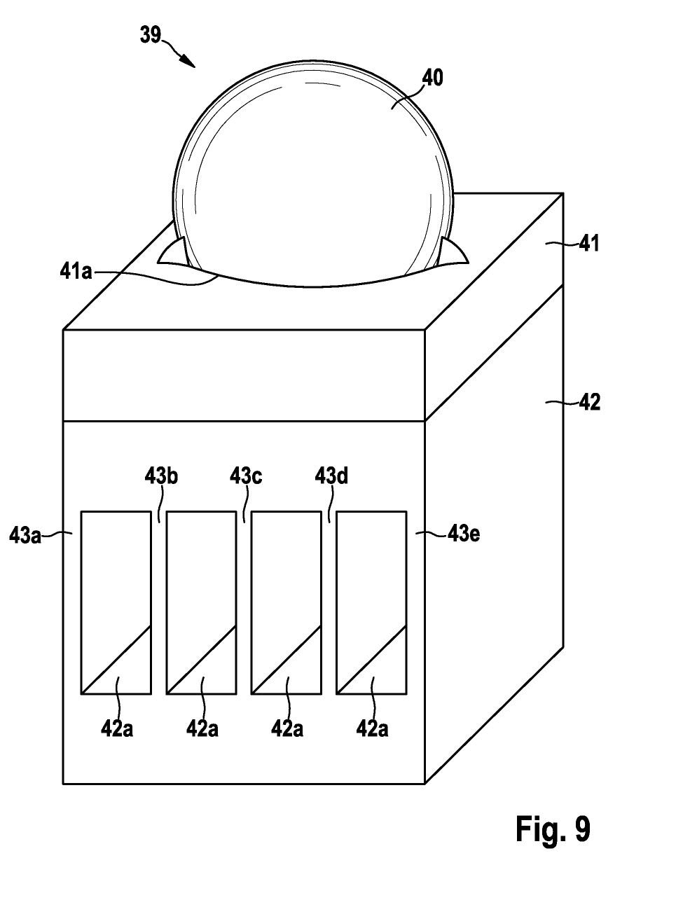

In a further configuration of a contact element 39, as illustrated in FIG. 9, a sphere 40, on which the substrate can bear, is fixed in a horizontal plate 41. The sphere 40 rests for fixing in an accurately fitting depression 41a of the plate 41. The plate 41 is connected to an articulation body 42. Said articulation body 42 has four parallelpipedal cutouts 42a arranged in parallel. These cutouts 42a form five solid-state articulations 43a-e arranged parallel. The sphere 40 connected to the articulation body 42 and the plate 41 are movable by a shear movement of the articulation body 42 in a direction perpendicular to the surfaces of the solid-state articulations 43a-e. The number of cutouts 42a and thus of solid-state articulations 43a-e is variable.

In one configuration, this contact element 39 is fixed on a mask holder 30 and used for the bearing of masks. The mask then lies on the top side of the sphere 40. In a variant of this contact element that is not illustrated in the figures, the surface of the plate 41 is a planar surface. Mask holders can be placed on said contact elements, in the case of which mask holders hemispheres were fixed as supporting elements, which can then bear on the horizontal plates 41 embodied in the planar fashion. This variant of contact elements are then arranged on a stage 2.

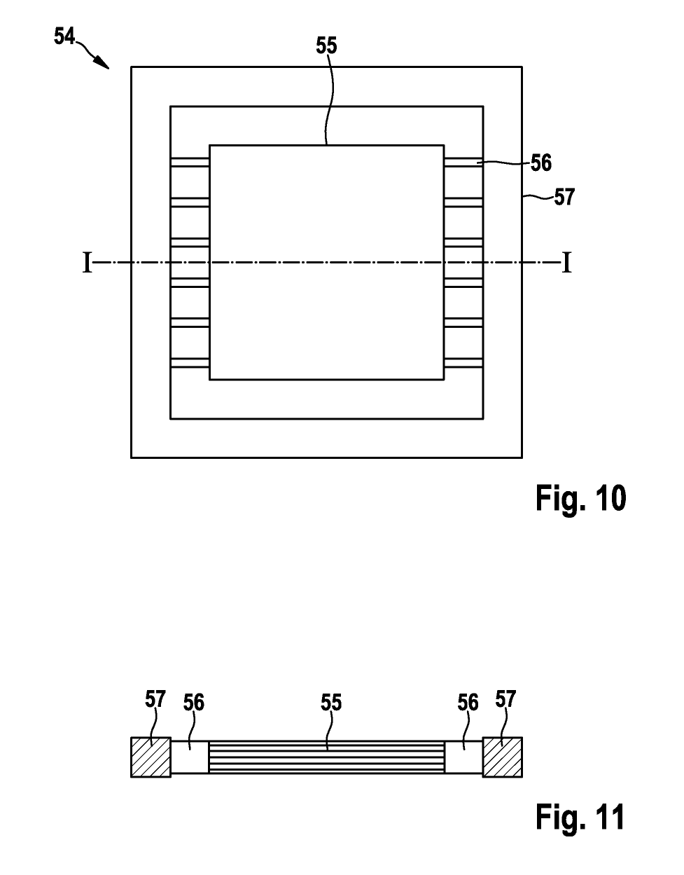

In a further configuration of a contact element 54, a horizontal plate 55 is connected to a frame by means of webs 56, as illustrated in FIG. 10. A section along the dashed line I-I is shown in FIG. 11. The webs are arranged in parallel at two opposite sides of the square horizontal plate. The webs correspond in terms of their height to the height of the plate 55. The thickness of the webs is chosen so as to enable the plate to move as freely as possible, but the directional stability and the reproducibility of the movement are maintained. The horizontal plate 55 is movable perpendicular to the direction of the webs. The frame 57 is fixed to a base element (not illustrated), a mask holder 30 or a stage 2.

In one configuration, this contact element 54 is fixed on a mask holder 30 and is used for bearing masks. A hemisphere (not illustrated in FIGS. 10 and 11) is then arranged on the horizontal plate, the mask bearing on said hemisphere. However, hemispheres as supporting elements can also be fixed to a substrate, and can then bear on the horizontal plates 35 embodied in a planar fashion.

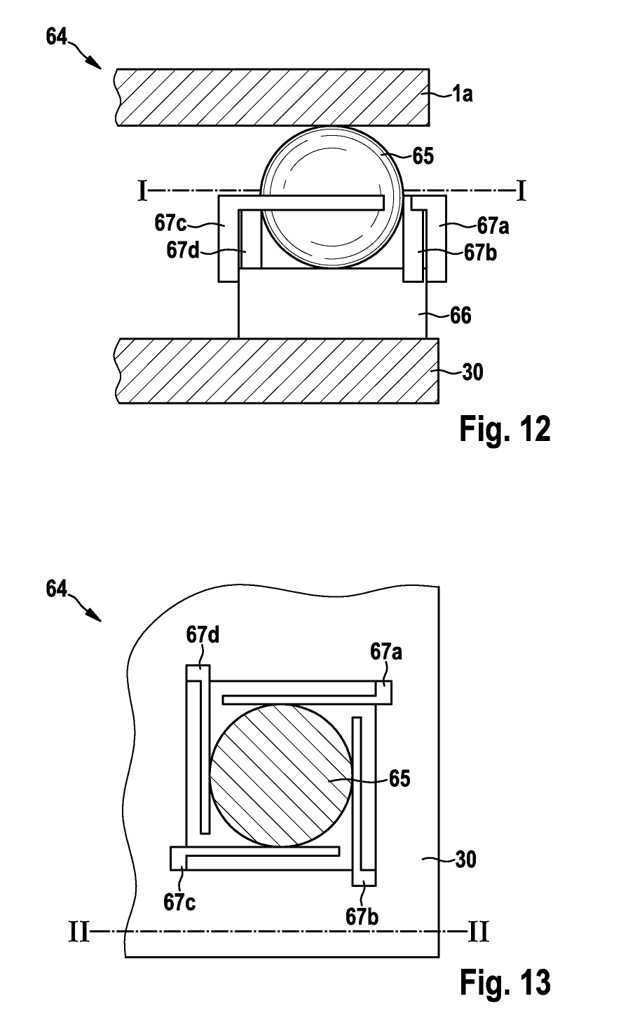

In a further configuration of a contact element 64, a sphere 65 lies freely movably on a planar plate 66, as illustrated in FIGS. 12 and 13. FIG. 12 is a section in the direction of the line II-II from FIG. 13. FIG. 13 is a section along the line I-I from FIG. 12. The planar plate 66 is fixed on the mask holder 30. A mask 1a as substrate becomes situated on the sphere 65. The sphere is secured against rolling away inadvertently by means of four flexible securing elements 67a-d. The securing elements 67a-d are fixed to the planar plate 66 by means of a vertical web. A flexible tongue arranged horizontally is fixed to the vertical web. The four tongues of the securing elements touch the surface of the sphere 65 in the rest position thereof. The four tongues of the securing elements are arranged along the sides of a square in the plan view. If the sphere 65 moves, the corresponding tongues are bent.

In one configuration, this contact element 64 is fixed on a mask holder 30 and is used for bearing masks or substrates with a planar underside. In a further variant the contact element 64 is arranged on a stage 2 and serves for bearing mask holders with planar underside.

Referring to FIG. 14, a further configuration of a contact element 74 is a variant of the contact element 64 mentioned above. A sphere 75 lies in a groove 76 having a V-shaped cross section. The groove 76 is formed in a plate 77 fixed on a mask holder 30. The substrate 1a becomes situated on the sphere 75. The sphere is secured against rolling away inadvertently along the groove 76 by means of two flexible securing elements 78, only one of the securing elements 78 being visible in FIG. 14. The securing elements 78 are fixed to the plate 77 by means of a vertical web. A flexible tongue arranged horizontally is fixed to the vertical web. The tongues of the securing elements 78 are perpendicular to the longitudinal direction of the groove 76. The two tongues of the securing elements touch the surface of the sphere 75 in the rest position thereof. If the sphere 75 moves along the groove 76, the corresponding tongue is bent. In the example shown in FIG. 14, the walls of the groove have an angle of 90°, wherein the angle bisector is perpendicular to the base element. The angle can also be in a range of, e.g., 60 to 120°.

In one configuration, this contact element 74 is fixed on a mask holder 30 and is used for bearing masks. In a further variant, the contact element 74 is arranged on a stage 2 and serves for bearing mask holders with a planar underside.

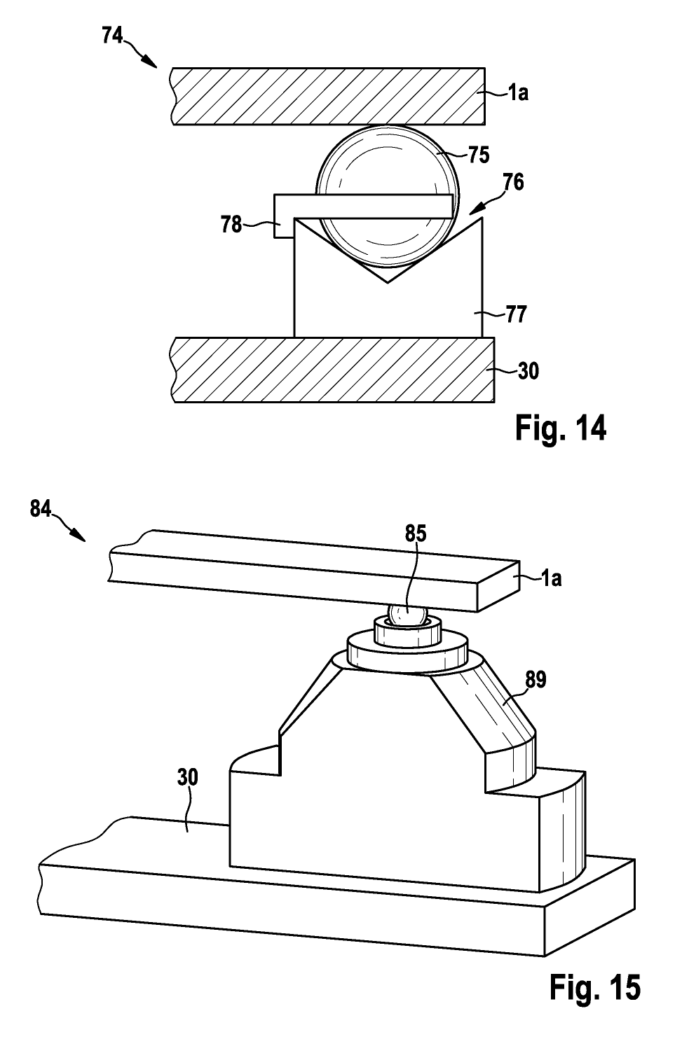

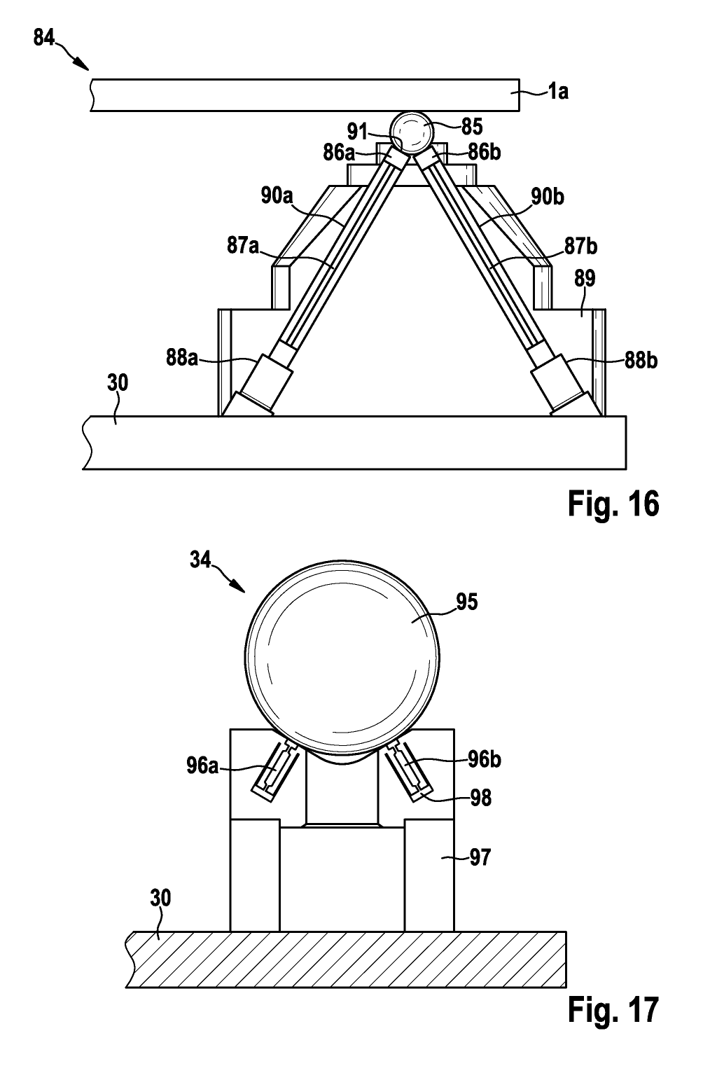

In a further configuration of a contact element 84 illustrated in FIGS. 15 and 16, a sphere 85 lies on the end faces of two first cylinders 86a, 86b said end faces being inclined in V-shaped manner relative to one another. In this example, on the side facing away from the sphere, each of the cylinders 86a, 86b is connected to a flexible rod 87a, 87b centrally along the axis of the cylinder. The rod is connected at its free end centrally to the end side of a second cylinder 88a, 88b. The rod runs along the axis of the second cylinder. The second cylinders have a first section having a first diameter and a second section having a second diameter, which is greater than the first diameter, and a step is formed at the transition from the first to the second section. The two cylinders and the rod in each case form a support. The diameter of the first cylinder corresponds to the diameter of the first section of the second cylinder. Two cylindrical holes 90a, 90b are formed in the main body 89 of the contact element. The diameter of said holes is slightly larger than the diameter of the first cylinder. The length of said holes corresponds to the distance from the end face of the first cylinder to the step of the second cylinder. A step is formed at that side of the holes which faces away from the sphere, and the diameter of the hole after said step corresponds to the diameter of the second section of the second cylinder. A depression 91 is formed in the top side of the main body, the sphere 85 becoming situated in said depression in a positively locking manner. If the supports are firstly introduced into the holes with the first cylinder from the opening facing away from the sphere until the second cylinder with the step becomes situated in an accurately fitting manner in the step of the hole then the sphere is raised somewhat by the end faces of the first cylinder. If a horizontal force acts on the sphere 85, the latter can rotate, wherein the elastic rods 87a, 87b of the supports bend reversibly. The sphere rotates about its midpoint to a good approximation. In this example, the end faces on which the sphere rests have an angle of 130°, wherein the angle bisector is perpendicular to the base element. The angle can also be in a range of, e.g., 50° to 160°.

In a further configuration (not illustrated in the figures) of said contact element 84, the sphere 85 rests on the end faces of three supports arranged symmetrically.

In one configuration, said contact element 84 is fixed on a mask holder 30 and is used for bearing masks 1a with a planar underside. In a further variant, the contact element 84 is arranged on a stage 2 and serves for bearing mask holders with a planar underside.

In a further configuration of a contact element 94, illustrated in FIG. 17, a sphere 95 lies on the end faces of two elastic supports 96a, 96b, said end faces being inclined in a V-shaped manner relative to one another. The supports are formed integrally with the main body 96a, 96b. The main body is formed as a parallelpiped having a constant thickness. Grooves 96a, 96b are milled into it, thus giving rise to the supports 96a, 96b. The supports are embodied elastically in the direction perpendicular to the grooves.

A V-shaped groove 98 is formed in the top side of the main body, in which groove the sphere 95 becomes situated on the end faces of the supports 96a, 96b.

If a horizontal force acts on the sphere 95, the latter can rotate, wherein the elastic supports bend reversibly. The rotation is effected horizontally in the plane of the drawing relative to FIG. 17. The sphere rotates about its midpoint to a good approximation.

In one configuration, said contact element 94 is fixed on a mask holder 30 and is used for bearing masks or substrates with a planar underside. In a further variant, the contact element 94 is arranged on a stage 2 and serves for bearing mask holders with a planar underside.

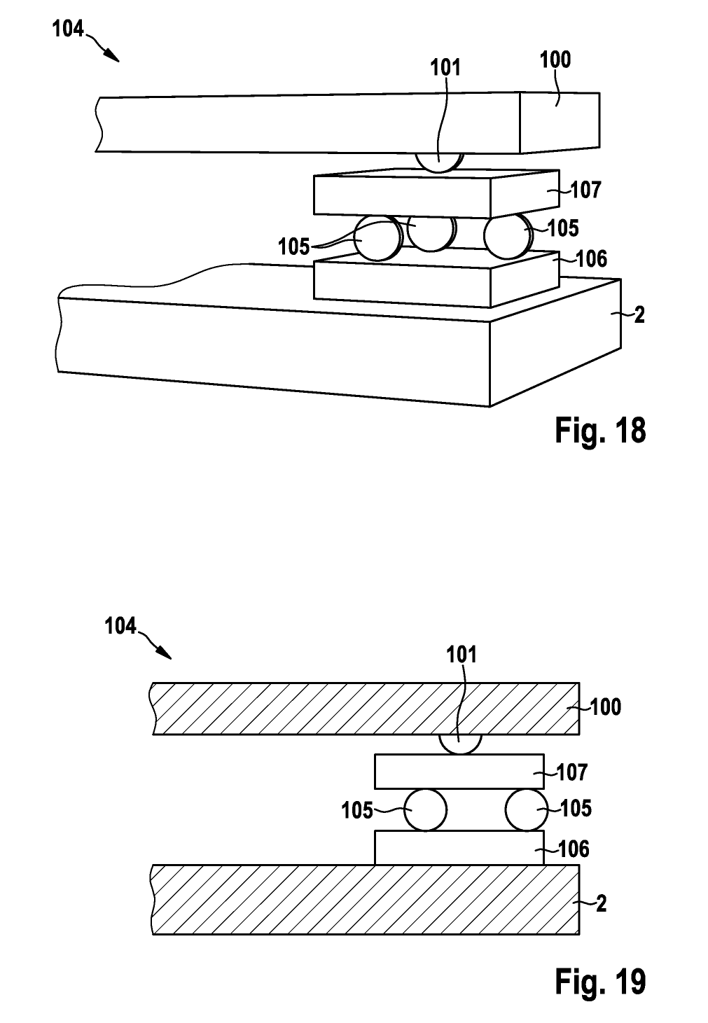

In a further configuration of a contact element 104, three spheres 105 lie freely movably on a first planar plate 106, as illustrated in FIGS. 18 and 19. A second planar plate 107 lies on the three spheres. The first planar plate 106 is connected to the base element, a stage 2. A mask holder 100 with a supporting element 101 in the form of a hemisphere can be placed onto the top side of the second plate 107. The forces are minimized by this contact element in all compensation directions, i.e. in all directions of the plane.

The spheres can be secured against rolling away inadvertently by means of securing elements (not illustrated in the drawings).

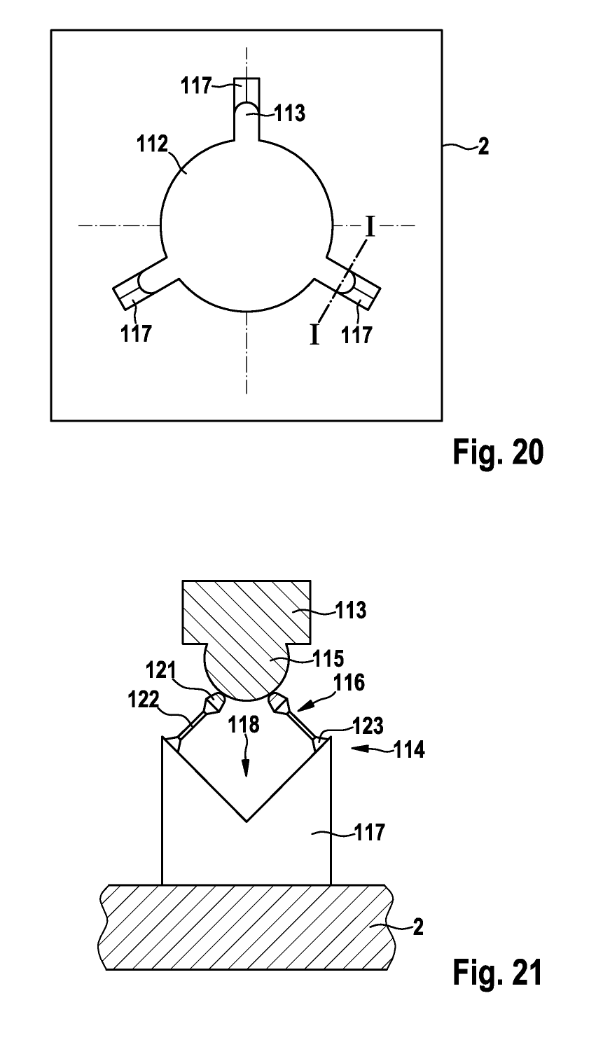

Referring to FIGS. 20 and 21, in a further configuration of a contact element 114, a hemispherical supporting element 115 lies on flexible elements 116 arranged at the walls of a V-shaped groove 118. The groove is formed in a plate 117 fixed on a stage 2. The contact elements 114 are arranged on the stage 2 in such a way that they form the corners of an equilateral triangle (not illustrated in the drawings). The grooves 118 in the plates 117 in each case run in the direction of the midpoint of the triangle. The supporting elements 115 are fixed to arms 113 of the mask holder 112. Further contact element (not illustrated in FIG. 20) for receiving the mask are arranged on the mask holder. The flexible elements have ellipsoids 121 that come into contact with the supporting element 115 of the mask holder 112. The ellipsoids 121 are fixed to bar-shaped solid-state articulations 122, which allow movement of the ellipsoid in all directions by bending. The solid-state articulations 122 are fixed to the surface of the walls of the groove 118 by means of a cone 123. Two elastic elements 116 in each case are arranged in a plane perpendicular to the groove 118. A moveability of the supporting element 115 along the groove 118 is thus made possible.

The contact elements are produced from high-grade steel or spring bronze, for example. Hemispheres or spheres on which the substrates become situated are produced from high-grade steel or from corundum, for example. The components can be connected by adhesive bonding, for example.

The contact elements described can be arranged in arbitrary combinations on a stage 2 and/or on a mask holder 30.

In one variant of a mask holder, three contact elements with a respective compensation direction are arranged at the corners of a triangle, wherein the compensation directions run from the corners in the direction of the midpoint of the triangle.

In one variant of a mask holder, three contact elements are arranged at the corners of a triangle. One contact element is embodied in a rigid fashion, one contact element has a compensation direction defined by the connection of this contact element and the rigid contact element. The third contact element acts in all compensation directions.

A number of implementations have been described. Nevertheless, it will be understood that various modifications may be made. For example, elements of one or more implementations may be combined, deleted, modified, or supplemented to form further implementations. In addition, other components may be added to, or removed from, the described position measuring device. In the examples shown in FIGS. 7 to 21, the contact elements may be configured to reduce (not necessarily minimize) the forces acting on the substrate by the contact elements in directions along the plane of the substrate. The contact elements can be made from materials different from those described above. Accordingly, other implementations are within the scope of the following claims.

What is claimed is:

1. A substrate holder for receiving a substrate, the substrate holder comprising
a base element; and
at least three contact elements that are connected to the base element and arranged in a plane;
wherein the substrate on being received by the substrate holder can lie on the at least three contact elements, and
wherein the contact elements are connected to the base element in such a way that forces acting on the substrate by at least one contact element in a direction of the plane are reduced.

2. The substrate holder according to claim 1, wherein the forces acting on the substrate are minimized in one respective direction per contact element.

3. The substrate holder according to claim 1, wherein the force acting on the substrate is minimized in one direction by each contact element.

4. The substrate holder according to claim 1, wherein the force acting on the substrate at a first contact element is minimized in all directions and the force acting on the substrate at a second contact element is minimized in one direction.

5. The substrate holder according to claim 1, wherein the contact element has a solid-state articulation for minimizing the forces.

6. The substrate holder according to claim 5, wherein the solid-state articulation has a flexible element enabling a movement of the contact element for minimizing the forces in a compensation direction.

7. The substrate holder according to claim 5, wherein the solid-state articulation has at least two flexible elements arranged parallel.

8. The substrate holder according to claim 5, wherein the solid-state articulation has at least two flexible elements which are embodied as webs and which enable a compensation movement parallel to the plane.

9. The substrate holder according to claim 1, wherein the contact element has a sphere arranged in a rotatable fashion.

10. The substrate holder according to claim 9, wherein the sphere bears on a planar surface arranged parallel to the plane.

11. The substrate holder according to claim 9, wherein the sphere lies in a groove running in the direction of the plane.

12. The substrate holder according to claim 9, wherein the sphere is held by securing elements in an initial position.

13. The substrate holder according to claim 9, wherein the sphere bears on at least two flexible supporting elements.

14. The substrate holder according to claim 1, wherein the contact element has three spheres arranged in a movable fashion between two planar surfaces.

15. The substrate holder according to claim 1, wherein a contact element has in each case two contact points, wherein the forces acting on the contact element are directed at least partly counter to one another.

16. The substrate holder according to claim 1, wherein there are six contact points between the contact elements and the substrate.

17. The substrate holder according to claim 1 in which the substrate comprises a mask holder.

18. The substrate holder according to claim 1 in which the substrate comprises a stage.

19. The substrate holder according to claim 1 in which the contact elements are connected to the base element in such a way that the forces acting on the substrate by the at least one contact element in a direction of the plane are minimized.

20. A position measuring device for determining a positioning error of a structure element on a mask, the position measuring device comprising:
a substrate holder for receiving a substrate, the substrate holder comprising:
a base element; and
at least three contact elements that are connected to the base element and arranged in a plane;
wherein the substrate on being received by the substrate holder can lie on the at least three contact elements, and
wherein the contact elements are connected to the base element in such a way that forces acting on the substrate by at least one contact element in a direction of the plane are minimized.

21. The position measuring device of claim 19 in which the forces acting on the substrate are minimized in one respective direction per contact element.

22. An apparatus comprising:
a substrate holder for receiving a substrate, the substrate holder comprising:
a base element; and
at least three contact elements that are connected to the base element and arranged in a plane, each contact element having a solid-state articulation member that has a flexible element enabling a movement of a portion of the contact element relative to the base element.

23. The apparatus of claim 22 in which the contact element comprises a rotatable sphere.

24. The apparatus of claim 23 in which the contact element comprises a plate having a groove, and the sphere lies in the groove.

25. The apparatus of claim 23 in which the contact element comprises at least two flexible supporting elements that contact the sphere.
